(19) United States
(12) Patent Application Publication
(10) Pub. No.: US 2026/0195775 A1
(43) Pub. Date: Jul. 9, 2026

(54) MEAT GRADE DETERMINATION METHOD AND APPARATUS USING AN ARTIFICIAL INTELLIGENCE MODEL

(71) Applicant: DEEPLANT, INC., Goyang-si (KR)

(72) Inventor: Chul-beom KIM, Goyangsi (KR)

(21) Appl. No.: 19/553,982

(22) Filed: Mar. 2, 2026

Related U.S. Application Data
(63) Continuation of application No. PCT/KR2024/013012, filed on Aug. 30, 2024.

(30) Foreign Application Priority Data
Sep. 5, 2023 (KR) 10-2023-0117320

(51) Int. Cl. G06Q 30/018; A22B 5/00; A22C 17/00; G06V 10/764; G06V 10/774; G06V 20/68

(52) U.S. Cl. CPC G06Q 30/018; A22B 5/007; A22C 17/008; G06V 10/764; G06V 10/774; G06V 20/68

(57) ABSTRACT

An embodiment relates to a meat grade determination method using an artificial intelligence model. The method includes generating a training data set including training meat images for at least one of Korean pork, Korean beef, and beef cattle, and grade information corresponding to the training meat images; and generating an artificial intelligence model trained, based on the training data set, to determine a grade of meat included in an input meat image.

### CROSS-REFERENCE TO RELATED APPLICATION

This application is based on and claims priority under 35 U.S.C. § 119 to PCT Patent Application No. PCT/KR2024/013012 filed on Aug. 30, 2024, Korean Patent Application No. 10-2023-0117320, filed on Sep. 5, 2023, in the Korean Intellectual Property Office, the disclosure of which is incorporated by reference herein in its entirety.

### BACKGROUND

### Technical Field

The present invention relates to a meat grade determination method and apparatus using an artificial intelligence model, and more particularly, to a technology for analyzing a meat image using an artificial intelligence model and determining a grade of meat included in the image.

### Background Art

Globally, meat consumption has shown a continuous increasing trend. As of 2021, chicken ranks first in global meat consumption, followed by pork and beef.

In 2021, pork consumption was 32.3 kg, and domestic beef consumption was 12.4 kg per capita. Recent consumers are able to obtain information on meat through various media and seek to purchase better-quality meat by comprehensively considering such information. This is because there are significant differences in taste and price depending on the grade of meat.

However, it is not easy for non-experts to determine meat grades, and evaluations of grades may differ among experts. This is because criteria such as marbling, meat color, texture, and palatability, which are major items for evaluating meat grades, vary depending on the evaluating expert and differ by country.

As described above, the lack of objective data to support evaluation results is the greatest cause of a decrease in reliability of meat grade evaluation.

Accordingly, there is an increasing need for a meat grade determination method and apparatus using an artificial intelligence, which analyzes a single meat image and determines a grade based on data possessed by an artificial intelligence trained with a plurality of meat images for each grade.

### SUMMARY

### Problem to be Solved

The present invention is intended to solve the problems of the conventional technology described above, and relates to a meat grade determination method and apparatus using an artificial intelligence, in which pre-trained artificial intelligence analyzes meat included in an image and determines a grade.

However, the technical problem to be achieved by the present embodiment is not limited to the technical problem described above, and other technical problems may exist.

### Means for Solving the Problem

As a technical means for achieving the above-described technical problem, an embodiment according to a first aspect of the present disclosure provides a meat grade determination method using an artificial intelligence model. The method includes: generating a training data set including training meat images for at least one of pork, Korean beef, and beef cattle, and grade information matched to the training meat images; and generating an artificial intelligence model trained to determine a grade of meat included in an input meat image based on the training data set.

In addition, an embodiment according to a second aspect of the present disclosure provides a meat grade determination apparatus. The apparatus includes a communication module, at least one processor, and a memory electrically connected to the processor and storing at least one code executed by the processor, wherein the memory stores code that, when executed by the processor, causes the processor to generate a training data set including training meat images for at least one of pork, Korean beef, and beef cattle and grade information matched to the training meat images, and to generate an artificial intelligence model trained to determine a grade of meat included in an input meat image based on the training data set.

### Effects of the Invention

The present invention is capable of providing consistent and highly accurate meat grade evaluation by an artificial intelligence trained with meat images classified by grade. In addition, the evaluation is performed by the artificial intelligence, thereby reducing costs and improving evaluation speed.

In addition, the present invention is capable of providing meat grade evaluation corresponding to grades of a respective country by performing evaluation based on the same criteria for each country.

In addition, by clarifying meat grade evaluation criteria, the present invention is capable of providing grounds indicating which items played a decisive role in evaluating a grade.

### BRIEF DESCRIPTION OF THE DRAWINGS

FIG. 1 is a diagram illustrating a meat grade determination apparatus according to an embodiment of the present invention and a terminal communicatively connected thereto.

FIG. 2 is a diagram illustrating the meat grade determination apparatus of FIG. 1 in detail.

FIG. 3 is a diagram illustrating grade prediction according to an embodiment of the present invention.

FIG. 4 is a diagram illustrating a process of obtaining sensory evaluation according to an embodiment of the present invention.

FIG. 5 is a diagram illustrating grade prediction results using an artificial intelligence model according to an embodiment of the present invention.

FIG. 6 is a diagram illustrating grade prediction results through an attention map (Attention Map) according to an embodiment of the present invention.

FIG. 7 is a flowchart illustrating a sequence of a meat grade determination method according to another embodiment of the present invention.

### DETAILED DESCRIPTION

Hereinafter, the present disclosure will be described in detail with reference to the accompanying drawings. However, the present disclosure may be implemented in various different forms and is not limited to the embodiments described herein. In addition, the accompanying drawings are provided only to facilitate understanding of the embodiments disclosed in the present specification, and the technical spirit disclosed in the present specification is not limited by the accompanying drawings. All terms including technical and scientific terms used herein should be interpreted as having meanings generally understood by those having ordinary skill in the art to which the present disclosure pertains. Terms defined in dictionaries should be interpreted as having meanings consistent with related technical literature and the content disclosed herein, and unless otherwise defined, should not be interpreted as having overly idealistic or restrictive meanings.

In order to clearly describe the present invention in the drawings, portions irrelevant to the description are omitted, and sizes, forms, and shapes of respective components shown in the drawings may be variously modified. Throughout the specification, identical or similar reference numerals are assigned to identical or similar parts.

Throughout the specification, when a part is described as being “connected (coupled, contacted, or joined)” to another part, this includes not only cases in which the part is “directly connected (coupled, contacted, or joined)” to the other part, but also cases in which the part is “indirectly connected (coupled, contacted, or joined)” with another member interposed therebetween. In addition, when a part is described as “including (comprising or being provided with)” a certain component, this means that other components are not excluded but may be further “included (comprised or provided),” unless otherwise specified to the contrary.

In the present specification, the term “unit” refers to a unit implemented by hardware, a unit implemented by software, or a unit implemented using both. In addition, one unit may be implemented using two or more pieces of hardware, and two or more units may be implemented by one piece of hardware. Meanwhile, a “unit” is not limited to software or hardware, and a “unit” may be configured to reside in an addressable storage medium or to reproduce one or more processors. Accordingly, by way of example, a “unit” includes components such as software components, object-oriented software components, class components, and task components, and includes processes, functions, attributes, procedures, subroutines, segments of program code, drivers, firmware, microcode, circuits, data, databases, data structures, tables, arrays, and variables. Functions provided within components and “units” may be combined into a smaller number of components and “units” or may be further separated into additional components and “units.” In addition, the components and “units” may be implemented to reproduce one or more CPUs in a device or a secure multimedia card.

In the following description, suffixes such as “module” and “unit” assigned to components are given or used interchangeably only for convenience of description, and do not in themselves have mutually distinguished meanings or roles. In addition, in describing embodiments disclosed in the present specification, detailed descriptions of related known technologies are omitted when it is determined that such descriptions may obscure the gist of the embodiments disclosed in the present specification.

In the present specification, terms indicating ordinals such as first and second are used only for the purpose of distinguishing one component from another component and do not limit the order or relationship of the components. For example, a first component of the present disclosure may be referred to as a second component, and similarly, a second component may also be referred to as a first component. Singular expressions used in the present specification should be interpreted as including plural expressions unless the context clearly indicates otherwise.

The “user terminal” referred to below may be implemented as a computer or a portable terminal capable of accessing a server or another terminal through a network. Here, the computer may include, for example, a notebook, a desktop, a laptop, or a VR HMD (for example, HTC VIVE, Oculus Rift, GearVR, DayDream, PSVR, etc.) equipped with a web browser (WEB Browser). Here, the VR HMD includes PC-based devices (for example, HTC VIVE, Oculus Rift, FOVE, Deepon, etc.), mobile-based devices (for example, GearVR, DayDream, {1} 73, Google Cardboard, etc.), console-based devices (PSVR), and independently implemented stand-alone models (for example, Deepon, PICO, etc.). The portable terminal may include, for example, a wireless communication device that ensures portability and mobility, such as a smartphone, a tablet PC, and a wearable device, as well as various devices equipped with communication modules such as Bluetooth (BLE, Bluetooth Low Energy), NFC, RFID, ultrasonic, infrared, WiFi, and LiFi. In addition, the “network” refers to a connection structure capable of exchanging information among respective nodes such as terminals and servers, and includes a local area network (LAN), a wide area network (WAN), the Internet (WWW: World Wide Web), wired and wireless data communication networks, telephone networks, and wired and wireless television communication networks. Examples of the wireless data communication network include, but are not limited to, 3G, 4G, 5G, 3GPP (3rd Generation Partnership Project), LTE (Long Term Evolution), WIMAX (World Interoperability for Microwave Access), Wi-Fi, Bluetooth communication, infrared communication, ultrasonic communication, visible light communication (VLC), and LiFi.

FIG. 1 is a diagram illustrating a meat grade determination apparatus and a terminal communicatively connected thereto according to an embodiment of the present invention.

Referring to FIG. 1, a meat grade determination apparatus (100) and a terminal (200) may be communicatively connected through a communication network. Hereinafter, the meat grade determination apparatus (100) may be referred to as a server. The server may be implemented as a cloud computing server such as Saas (Software as a Service), PaaS (Platform as a Service), or IaaS (Infrastructure as a Service). In addition, the server may be constructed in the form of a private cloud, a public cloud, or a hybrid cloud system, but the scope of the present invention is not limited thereto. In addition, the meat grade determination apparatus (100) may be operated using an artificial intelligence model.

The meat grade determination apparatus (100) generates a training data set including training meat images for at least one or more types of meat and grade information matched to the training meat images.

The meat grade determination apparatus (100) generates an artificial intelligence model trained to determine a grade of meat included in an input meat image based on the training data set.

The terminal (200) may transmit an image to the meat grade determination apparatus (100). In addition, the terminal (200) may receive a meat grade together with visualization data from the meat grade determination apparatus (100).

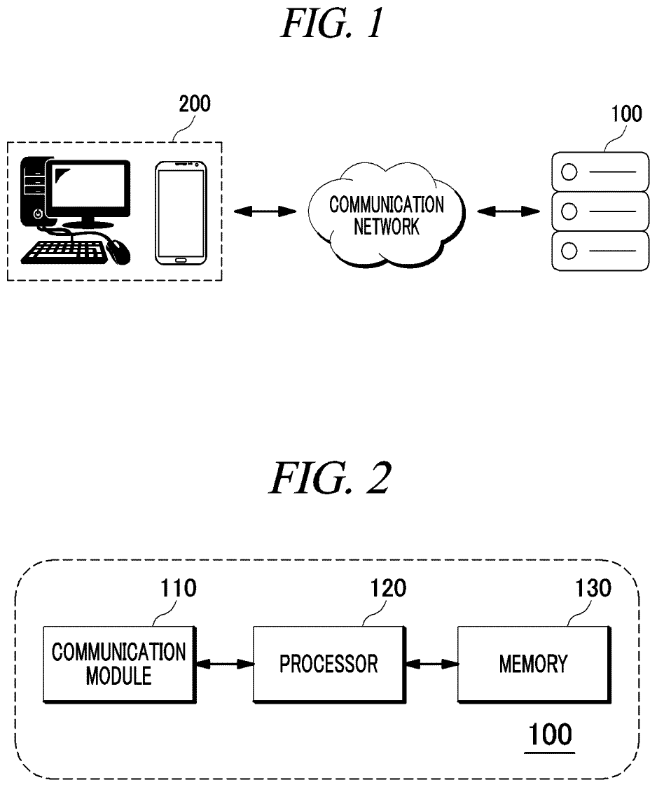

FIG. 2 is a diagram illustrating the meat grade determination apparatus (100) of FIG. 1 in detail.

Referring to FIG. 2, the meat grade determination apparatus (100) may include a communication module (110), a processor (120), and a memory (130).

The communication module (110) may include a device including hardware and software necessary to transmit and receive signals such as control signals or data signals through wired or wireless connections with other network devices.

The communication module (110) may receive a meat image from the terminal (200). In addition, the communication module (110) may provide a meat grade to the terminal (200) as visualization data including images, graphs, and tables. However, the present invention is not limited thereto, and as needed, the communication module (110) may receive images or videos from an external device or a database other than the terminal (200).

The processor (120) may include various types of devices for controlling and processing data. The processor (120) may refer to a data processing device embedded in hardware and having a physically structured circuit to perform functions expressed as code or instructions included in a program.

For example, the processor (120) may be implemented in the form of a microprocessor, a central processing unit (CPU), a processor core, a multiprocessor, an application-specific integrated circuit (ASIC), a field programmable gate array (FPGA), or the like, but the scope of the present invention is not limited thereto.

The processor (120) performs operations according to code stored in the memory (130).

The memory (130) may store at least one or more of information and data input through the communication module (110), information and data required for functions performed by the processor (120), and data generated according to execution of the processor (120).

The memory (130) should be interpreted as collectively referring to non-volatile storage devices that retain stored information even when power is not supplied and volatile storage devices that require power to retain stored information. The memory (130) may include magnetic storage media or flash storage media in addition to volatile storage devices that require power to retain stored information, but the scope of the present invention is not limited thereto.

The memory (130) is electrically connected to the processor (120), and stores at least one code executed by the processor (120). The memory (130) stores code that, when executed by the processor (120), causes the processor (120) to perform the following functions and procedures.

The memory (130) stores code that causes generation of a training data set including training meat images for at least one or more types of meat and grade information matched to the training meat images. For example, the grade information may be set based on criteria for determining a plurality of pre-established country-specific beef grades or pork grades.

The memory (130) stores code that causes generation of an artificial intelligence model trained to determine a grade of meat included in an input meat image based on the training data set.

The memory (130) stores code that causes reception of a meat image subject to grade determination and determination of a grade for the meat image using the artificial intelligence model. For example, the grade of meat included in the meat image may include at least one grade among a plurality of country-specific grades.

The memory (130) stores code that causes, when a request for grade determination of a specific country is received from the communicatively connected terminal (200), determination of meat included in the meat image based on criteria corresponding to the grade of the specific country.

The memory (130) stores code that causes generation of visualization data visualizing a partial region of the meat image as a basis for the determined meat grade. For example, the partial region may be a meat region in which protein included in the meat image is included at or above a predetermined level.

The memory (130) stores code that causes provision of an interface including a grade, an evaluation score, a meat image, a QR code, and visualization data to the terminal (200) communicatively connected to the processor (120).

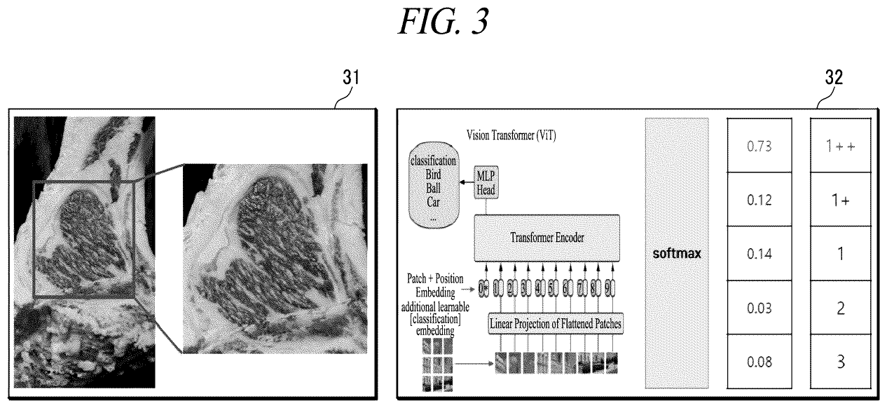

FIG. 3 is a diagram illustrating a grade prediction process according to an embodiment of the present invention.

Referring to FIG. 3, when the meat grade determination apparatus (100) receives a meat image from the terminal (200), the meat grade determination apparatus (100) may segment and crop a portion of the meat to be evaluated, and then resize the image (31). Through this, loss of information may be minimized. Then, transfer learning may be performed on the resized image through a pre-trained artificial intelligence model. Thereafter, the grade of the meat may be determined (32) using the artificial intelligence model.

At this time, the artificial intelligence model used for transfer learning may use a CNN (Convolutional Neural Network) and a ViT (Vision Transformer).

A CNN is a deep learning model that detects features of an image through convolution operations, and through this, classifies input data or extracts and learns meaningful information.

A ViT is a deep learning model that uses an attention mechanism for image processing, and is effective in extracting global information and performing classification by converting images into tokens.

More specifically, image tasks are implemented in a Transformer-structured model, in which Vision tasks are implemented without using a CNN, but by using a multi-head attention structure of a Transformer. Through this, compared with other CNN-based models, the VIT exhibits excellent performance and can consume fewer computational resources during a training process.

At this time, large values are emphasized based on Q (Query), K (Key), and V (Value), and these correspond to representations of elements that are core to learning.

Training management of the artificial intelligence model as described above may use a pre-established library. The library supports tracking experiments of machine learning models and sharing models.

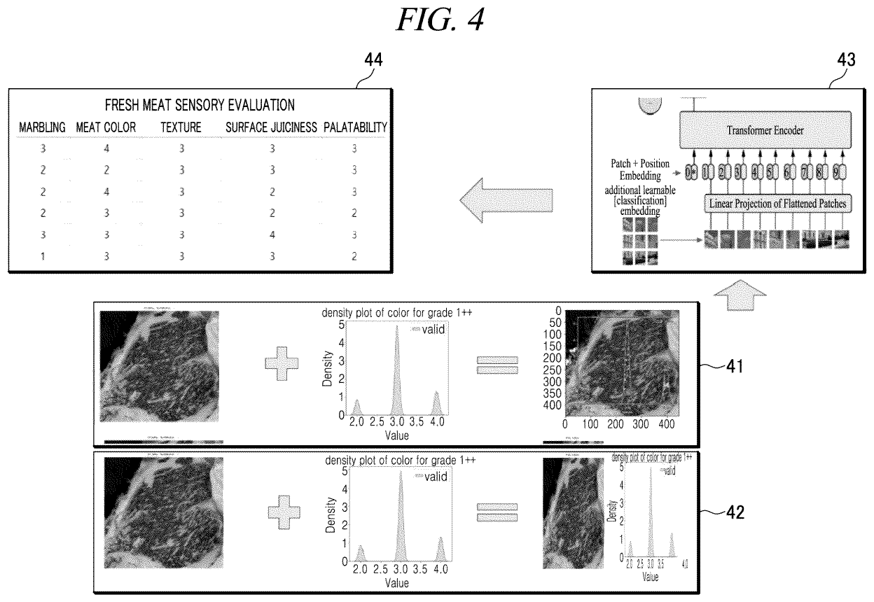

FIG. 4 is a diagram illustrating a process of obtaining a sensory evaluation table according to an embodiment of the present invention.

Referring to FIG. 4, a meat image may be received from the terminal (200), and a color distribution graph of a corresponding grade may be combined and displayed. At this time, the meat image and the color distribution graph may be arranged to overlap (41), or the meat image and the color distribution graph may be arranged side by side (42). In addition, a sensory evaluation table (44) may be obtained by utilizing an artificial intelligence model (43). The sensory evaluation table (44) may include marbling, meat color, texture, surface juiciness, and palatability.

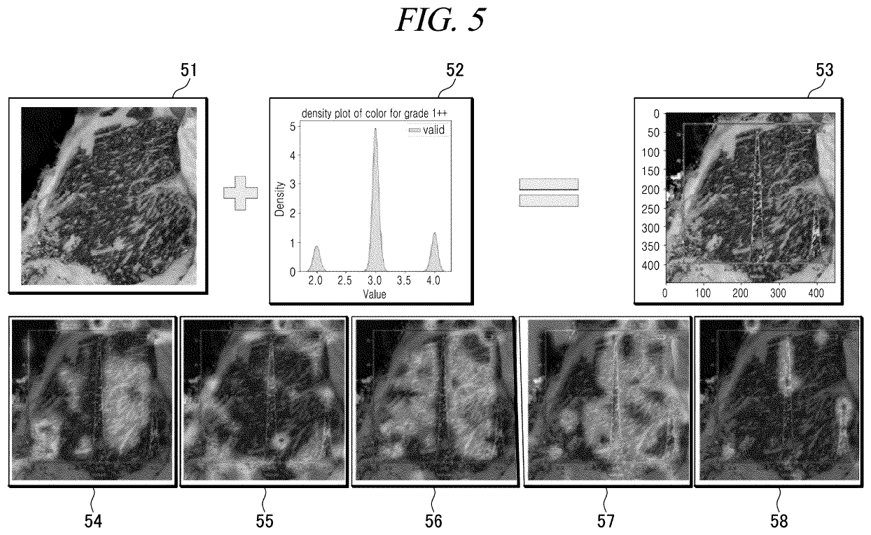

FIG. 5 is a diagram illustrating visualization of grade prediction results using an artificial intelligence model according to an embodiment of the present invention.

Referring to FIG. 5, it can be confirmed that contributions for each grade of meat are visualized using color distribution graphs for the respective grades. In FIG. 5, a meat image (51) may be combined with a color distribution graph (52) to be displayed as a color distribution image (53). In addition, target grades of meat are classified into 1++, 1+ grade, 1 grade, 2 grade, and 3 grade, and by applying a Grad-CAM technique to each corresponding meat grade, it is possible to confirm visualization results indicating which portions contribute more. In this case, portions closer to red in the meat image indicate portions that contribute more to the model's prediction. For example, in FIG. 5, the grade of meat is determined according to portions marked in red in each meat image of grades 1++ to 3 (54 to 58).

Grad-CAM (Gradient-weighted Class Activation Mapping) is a technique for visualizing prediction results of a deep learning model, and can emphasize and display how much a specific portion of an image contributes to a model's decision. Through this, it is possible to visually understand which portions are mainly utilized by the model and to interpret the model's predictions.

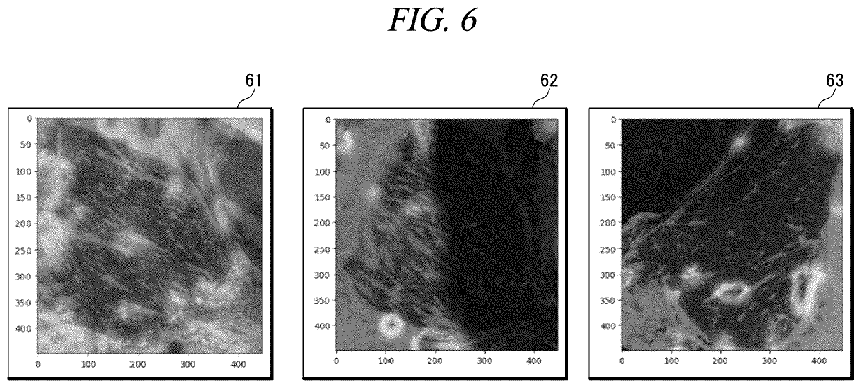

FIG. 6 is a diagram illustrating grade prediction results through an attention map (Attention Map) according to an embodiment of the present invention.

Referring to FIG. 6, the meat grade determination apparatus (100) converts a latent vector, obtained from a meat image received from the terminal (200) by a ViT (Vision Transformer)-based artificial intelligence model, into a square form, resizes the latent vector to the same size as the original image, and visualizes the result (61 to 63). For example, as shown in FIG. 6, portions closer to blue within the meat image have greater weights.

Techniques used for visualizing an image may include the Grad-CAM (Gradient-weighted Class Activation Mapping) described with reference to FIG. 5 and an Attention Map.

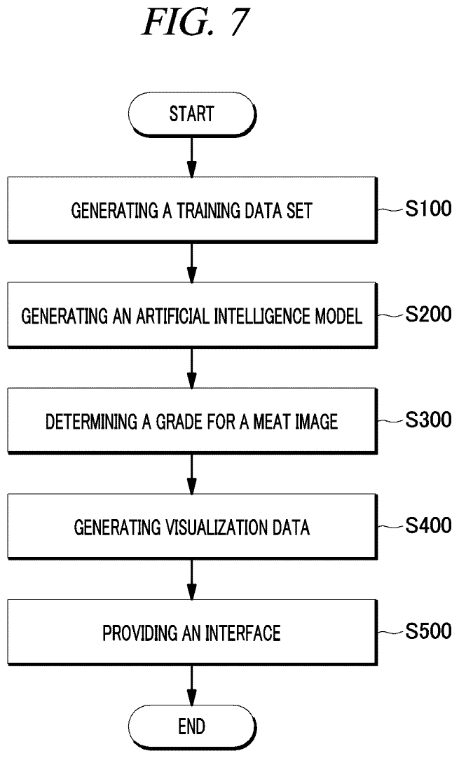

FIG. 7 is a flowchart illustrating a sequence of a meat grade determination method according to another embodiment of the present invention.

A platform safety door control method to be described below may be performed by the meat grade determination apparatus (100) described above with reference to FIGS. 1 to 6. Accordingly, the content of the embodiments of the present disclosure described above with reference to FIGS. 1 to 6 may be equally applied to the embodiments to be described below, and descriptions overlapping with those described above will be omitted. The steps described below are not necessarily performed in order, and the order of the steps may be variously set, and the steps may be performed substantially simultaneously.

Referring to FIG. 7, the meat grade determination method includes a training data set generation step (S100), an artificial intelligence model generation step (S200), a step of determining a grade for a meat image (S300), a visualization data generation step (S400), and an interface provision step (S500).

The training data set generation step (S100) is a step of generating a training data set including training meat images for at least one or more types of meat and grade information matched to the training meat images.

The artificial intelligence model generation step (S200) is a step of generating an artificial intelligence model trained to determine a grade of meat included in an input meat image based on the training data set.

The step of determining a grade for a meat image (S300) is a step of receiving a meat image subject to grade determination and determining a grade for the meat image using the artificial intelligence model. Alternatively, when a request for grade determination of a specific country is received from the terminal (200) communicatively connected to the processor, meat included in the meat image may be determined and provided based on criteria corresponding to the grade of the specific country.

The visualization data generation step (S400) is a step of generating visualization data visualizing a partial region of the meat image as a basis for the determined meat grade.

The interface provision step (S500) is a step of providing an interface including a grade, an evaluation score, a meat image, a QR code, and visualization data to the terminal (200) communicatively connected to the processor.

An embodiment of the present invention may also be implemented in the form of a recording medium storing computer-executable instructions such as program modules executed by a computer. A computer-readable medium may be any available medium that can be accessed by a computer, and includes all volatile and non-volatile media, and removable and non-removable media. In addition, computer-readable media may include all computer storage media. Computer storage media include all volatile and non-volatile, removable and non-removable media implemented by any method or technology for storage of information such as computer-readable instructions, data structures, program modules, or other data.

Although the methods and systems of the present invention have been described in connection with specific embodiments, some or all of the components or operations thereof may be implemented using a computer system having a general-purpose hardware architecture.

Those having ordinary skill in the art to which the present disclosure pertains will understand that, based on the above description, various modifications and variations may be readily made in other specific forms without departing from the technical spirit or essential features of the present disclosure. Therefore, the embodiments described above should be understood in all respects as illustrative and non-limiting. The scope of the present disclosure is defined by the appended claims rather than the foregoing detailed description, and all changes or modifications derived from the meaning and scope of the claims and their equivalents should be interpreted as being included in the scope of the present disclosure. The scope of the present application is defined by the appended claims rather than the foregoing detailed description, and all changes or modifications derived from the meaning and scope of the claims and their equivalents should be interpreted as being included in the scope of the present application.

What is claimed is:

1. A meat grade determination method using an artificial intelligence model executed by a processor, the method comprising:
a) generating a training data set including at least one training meat image and grade information corresponding to the training meat image; and
b) generating an artificial intelligence model trained, based on the training data set, to determine a grade of meat included in an input meat image.

2. The meat grade determination method of claim 1,
further comprising:
c) receiving a meat image to be subjected to grade determination, and determining a grade of the meat image using the artificial intelligence model.

3. The meat grade determination method of claim 1,
wherein the grade information is set based on criteria for determining predefined beef grades or pork grades for a plurality of countries.

4. The meat grade determination method of claim 2,
wherein the grade of the meat included in the meat image determined in step c) includes at least one grade among a plurality of country-specific grades,
and wherein step c) comprises:
when a request for grade determination of a specific country is received from a terminal communicatively connected to the processor, determining and providing a grade of the meat included in the meat image based on criteria corresponding to the grade of the specific country.

5. The meat grade determination method of claim 1,
further comprising:
d) generating visualization data that visualizes a partial region of the meat image as a basis for the meat grade determined in step c).

6. The meat grade determination method of claim 5,
wherein the partial region is a meat region including protein contained in the meat image at or above a predetermined level.

7. The meat grade determination method of claim 1,
further comprising:
e) providing, to a terminal communicatively connected to the processor, an interface including a grade, an evaluation score, a meat image, a QR code, and visualization data.

8. A meat grade determination apparatus comprising:
a communication module;
at least one processor; and
a memory electrically connected to the processor and storing at least one code executed by the processor,
wherein the memory stores code that, when executed by the processor, causes the processor to:
generate a training data set including at least one training meat image and grade information corresponding to the training meat image; and
generate an artificial intelligence model trained, based on the training data set, to determine a grade of meat included in an input meat image.

9. The meat grade determination apparatus of claim 8,
wherein the memory stores code that, when executed by the processor, causes the processor to:
receive a meat image to be subjected to grade determination;
determine a grade of the meat image using the artificial intelligence model;
generate visualization data visualizing a partial region of the meat image as a basis for the determined meat grade; and
provide, to a terminal communicatively connected to the processor, an interface including the grade, an evaluation score, the meat image, a QR code, and the visualization data.

10. The meat grade determination apparatus of claim 8,
wherein the grade information is set based on criteria for determining predefined beef grades or pork grades for a plurality of countries.

11. The meat grade determination apparatus of claim 9,
wherein the grade of the meat included in the meat image includes at least one grade among a plurality of country-specific grades,
and wherein the memory stores code that, when executed by the processor, causes the processor to:
when a request for grade determination of a specific country is received from a terminal communicatively connected to the processor, determine and provide a grade of the meat included in the meat image based on criteria corresponding to the grade of the specific country.

12. The meat grade determination apparatus of claim 9,
wherein the partial region is a meat region including protein contained in the meat image at or above a predetermined level.
